(19) United States
(12) Patent Application Publication
(10) Pub. No.: US 2008/0013263 A1
(43) Pub. Date: Jan. 17, 2008

(54) Enclosure for Visual Monitor

(75) Inventors: Daniel R. Ringler, Elizabethville, PA (US); Jason M'Cheyne Reisinger, Carlisle, PA (US); Attalee S. Taylor, Palmyra, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Middletown, PA (US)

(21) Appl. No.: 11/457,561

(22) Filed: Jul. 14, 2006

(51) Int. Cl. G06F 1/16

(52) U.S. Cl. 361/681; 361/683

(57) ABSTRACT

An enclosure includes a first enclosure member and a second enclosure member for securing a monitor, a printed circuit board and a switch therebetween. An actuator is formed of unitary construction with the first enclosure member. The first and second enclosure members are secured by a plurality of connections. A tool is configured to substantially simultaneously disengage the plurality of connections.

### FIELD OF THE INVENTION

The present invention is directed to an enclosure, and more specifically, to an enclosure for a visual monitor.

### BACKGROUND OF THE INVENTION

Enclosures are required to surround and protect visual monitors and associated components. Typically, the enclosure includes a shell that is assembled together, such as by fasteners. However, as the size of visual monitors continue to decrease, use of fasteners are also correspondingly reduced, increasing the difficulty of assembly. Additionally, the cost of loose features and assembly labor increases the cost of the enclosure assembly.

What is needed are enclosures for securing visual monitors and associated components that can be easily and quickly assembled and disassembled, involving a minimum of loose parts.

### SUMMARY OF THE INVENTION

The present invention relates to an enclosure including a first enclosure member having an inner surface and an outer surface. A plurality of first connector portions are formed in the first enclosure member. A second enclosure member has an inner surface and an outer surface including a plurality of second connector portions formed in the second enclosure member. Each second connector portion and a corresponding first connector portion secure the first enclosure member to the second enclosure member upon the engagement of the plurality of first connector portions with the plurality of second connector portions. A plurality of features are formed in at least one of the first enclosure member and the second enclosure member. Each of the plurality of features correspond to an engagement of a first connector portion with a second connector portion so as to permit substantially simultaneous disengagement of the plurality of first connector portions from the plurality of second connector portions by a tool. A monitor, a printed circuit board and a switch are disposed between the first enclosure member and second enclosure member.

The present invention further relates to a tool for separating an enclosure. The tool includes a base and a plurality of protrusions extending away from the base to engage a corresponding plurality of connections between a first enclosure member and a second enclosure member. The first enclosure member and second enclosure member form an enclosure for securing a monitor, a printed circuit board and a switch between the first enclosure member and second enclosure member. Upon the plurality of protrusions making sufficient physical contact with the plurality of connections, each of the plurality of connections are disengaged.

The present invention yet further relates to a method for disassembling an enclosure. The steps include providing a first enclosure member in locking engagement with a second enclosure member for securing a monitor, a printed circuit board and a switch between the first enclosure member and second enclosure member. The locking engagement is achieved by a plurality of engaging fasteners between the first enclosure member and the second enclosure member. The method further includes the step of providing a tool to disengage the first enclosure member from the second enclosure member. The method includes the step of directing the engaged first enclosure member and second enclosure member into physical contact with the tool, wherein the tool substantially simultaneously disengages the plurality of engaging fasteners.

An advantage of the present invention is that the total number of parts to fabricate the enclosure is reduced.

A further advantage of the present invention is that a single tool can be used to disconnect the plurality of connections between the first enclosure member and the second enclosure member substantially simultaneously.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an assembled enclosure containing a monitor of the present invention.

FIG. 2 is an exploded perspective view of the enclosure containing a monitor of the present invention.

FIG. 3 is an exploded perspective view in which a monitor is assembled to one enclosure member of the present invention.

FIG. 4 is a perspective view of inner surfaces of enclosure members of the present invention.

FIG. 5 is a partial cutaway view of an enclosure member, including a cross section taken along line 5-5 taken from FIG. 3 of the present invention.

FIG. 6 is an exploded perspective view of enclosure members of the enclosure of the present invention.

FIG. 7 is a bottom perspective view of an enclosure member of the enclosure of the present invention.

FIGS. 8-10 are each enlarged, partial cross sections taken from line 8-8 of FIG. 1 of the present invention.

FIG. 11 is a perspective view of a tool usable to disassemble the enclosure of the present invention.

FIG. 12 are combined cutaway views of an enclosure assembly for disassembly by a tool, including cross sections taken from line 12-12 of FIG. 1 for the enclosure assembly and from line 11-11 of FIG. 11 for the tool of the present invention.

FIG. 13 is an enlarged partial cutaway view of FIG. 12 of the present invention.

Wherever possible, the same reference numbers will be used throughout the drawings to refer to the same or like parts.

### DETAILED DESCRIPTION OF THE INVENTION

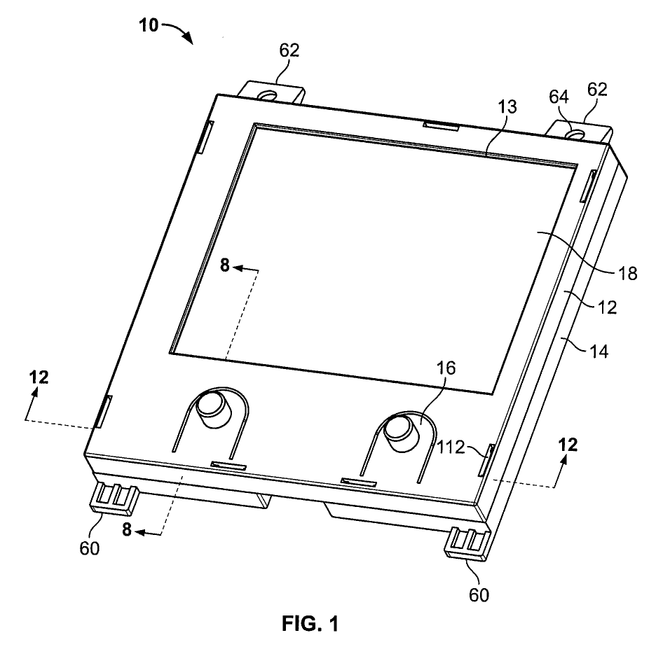

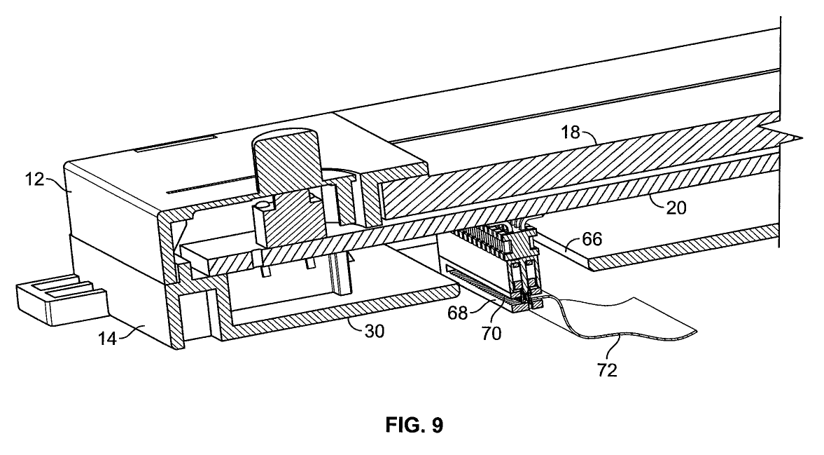

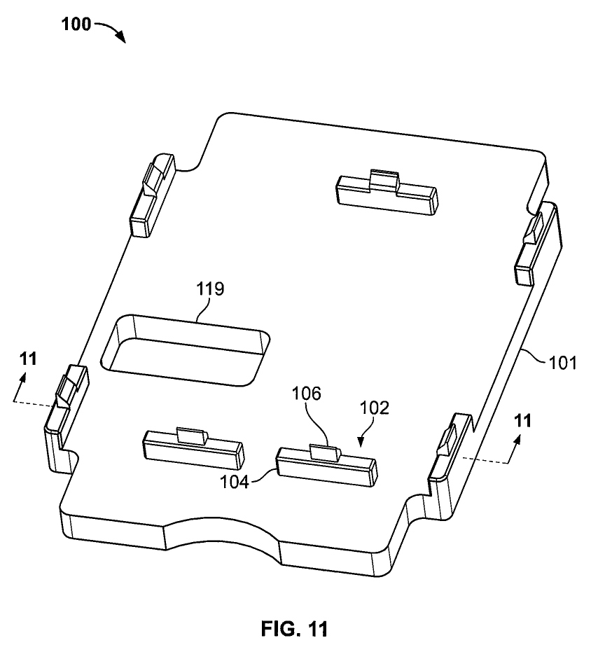

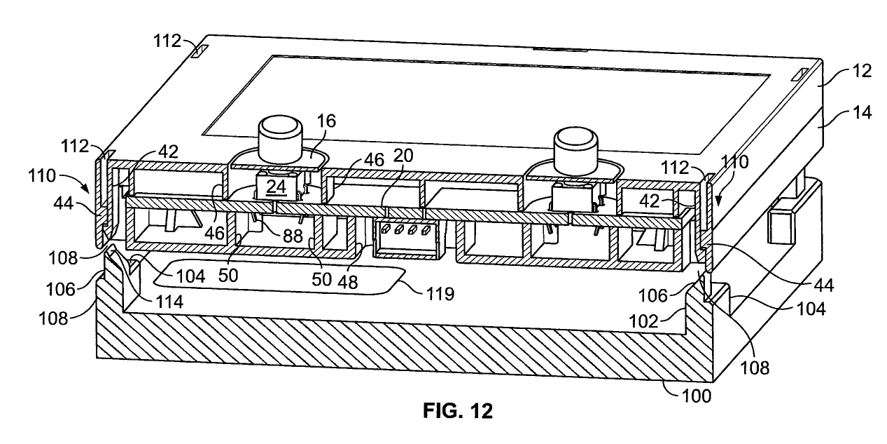

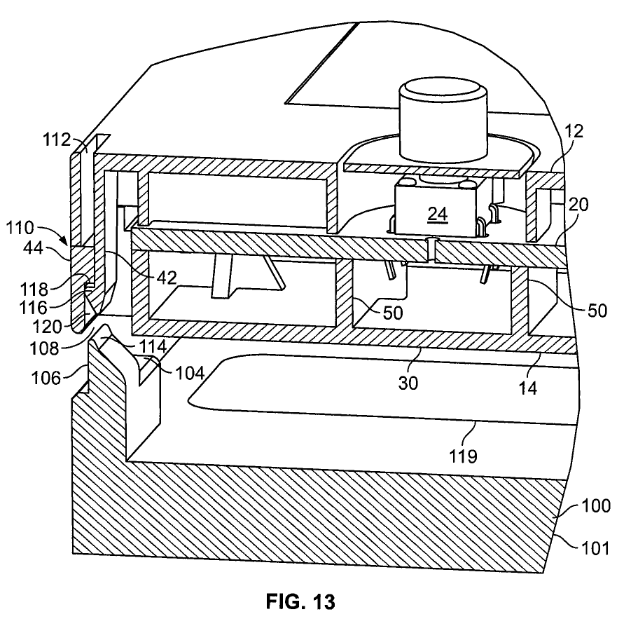

The present invention is directed to an enclosure 10 as depicted in FIGS. 1-13. Enclosure 10 includes an enclosure member 12 and an enclosure member 14 that form engaged connections 110 (see FIGS. 12-13) to secure enclosure member 12 and enclosure member 14 together to house a monitor 18, a printed circuit board 20 or board, and a pair of switches 24, forming a monitor assembly. The switches 24 control the operation of monitor 18. Optionally, a spacer 22, or plurality of spacers 22, is disposed between monitor 18 and board 20. Spacer 22 is preferably composed of a resilient layer of material that will prevent electrostatic discharge between monitor 18 and board 20. Resilient spacer 22 is also configured to be compressed when enclosure members 12, 14 are brought together, the compressed spacer 22 accounting for manufacturing tolerances between the enclosure members and minimizing relative movement of the monitor 18 and board 20 with respect to the enclosure members. A tool 100 (see FIGS. 11-13) is configured to permit convenient disassembly of enclosure members 12, 14 by disengaging the engaged connections 110 between the enclosure members substantially simultaneously.

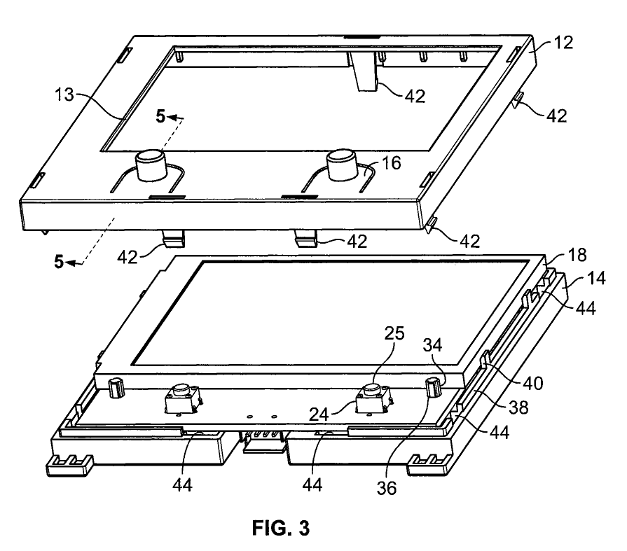

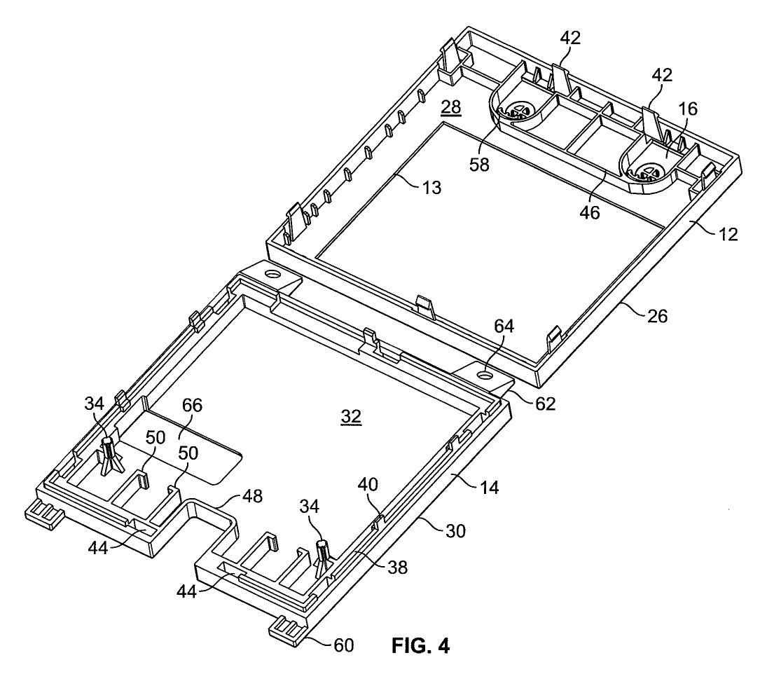

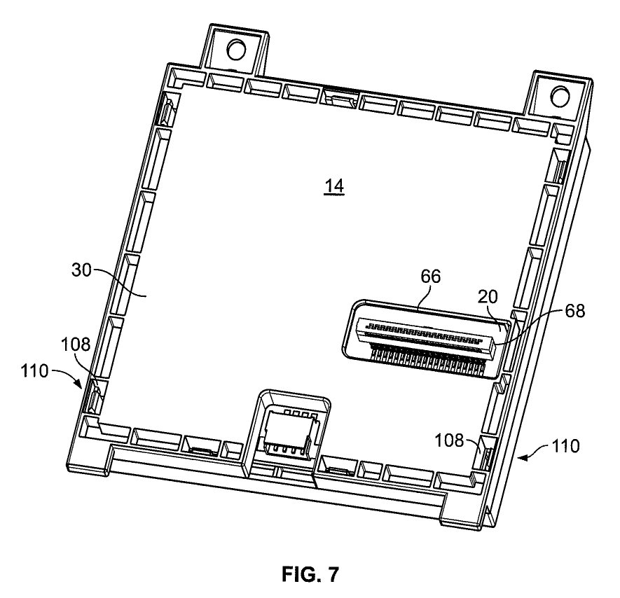

Referring to FIGS. 1-6, enclosure member 14 includes an outer surface 30 and an inner surface 32, and is preferably composed of a non-metal material and manufactured by injection molding or other technique capable of high quantity production. Preferably, guides 38 extend along the periphery of enclosure member 14 and away from inner surface 32 and tabs 40, which further extend from guides 38, also extend away from the inner surface. As shown in FIG. 4, each of a pair of alignment posts 34 extends outwardly from inner surface 32. Each alignment post 34 corresponds to an aperture 36 formed in board 20 to assist in properly aligning the board in enclosure member 14. In combination with guides 38 and tabs 40, posts 34 can be used to position monitor 18 (see FIG. 3). Formed between alignment posts 34 is a protruding structure 48 or pedestal that extends away from inner surface 32 for structurally supporting the portion of the board 20 containing switches 24. Specifically, protruding structure 48 includes legs 50 that are configured to substantially surround the footprint of each switch 24 on board 20 without interfering with electrical contacts 88 (see FIG. 12) connecting switch 24 to board 20. An opening 66 is formed in enclosure member 14 through which an electrical connector 68 (see FIG. 7) that is connected to board 20 extends.

Optionally, enclosure member 14 includes a pair of tabs 60 extending outwardly from the periphery of the enclosure member. Similarly, a second pair of tabs 62 extend outwardly from the periphery of the enclosure member 14 opposite tabs 60. Tabs 60, 62 are retention features to secure enclosure 10 to another structure, (not shown) if desired. For example, tabs 60 are configured to engage corresponding recesses in the structure, while tabs 62 each include an aperture 64 that is configured to receive a fastener (not shown). As will be described below in additional detail, tabs 60, 62 can also be used in conjunction with tool 100 to assist in disassembling or disengaging enclosure member 12 from enclosure member 14.

Referring to FIGS. 1-5, enclosure member 12 includes an outer surface 26 and an inner surface 28, and preferably is composed of a non-metal material and manufactured by injection molding or other technique capable of high quantity production. Enclosure member 12 preferably includes an opening 13 for viewing monitor 18. However, if the material is substantially transparent, opening 13 may not be required. Adjacent opening 13 is at least one, and as shown in the figures, a pair of actuators 16 that are used to control monitor 18 by interacting with corresponding switches 24. Preferably, actuator 16 is formed of unitary construction with enclosure member 12. Actuator 16 includes a flap 52 and a button 54 that extends away from the outer surface 26 of enclosure member 12. Button 54 is preferably formed of unitary construction with flap 52, although button 54 could be adhered or otherwise fastened to the flap. A primary purpose of button 54 is convenient tactile access by a user.

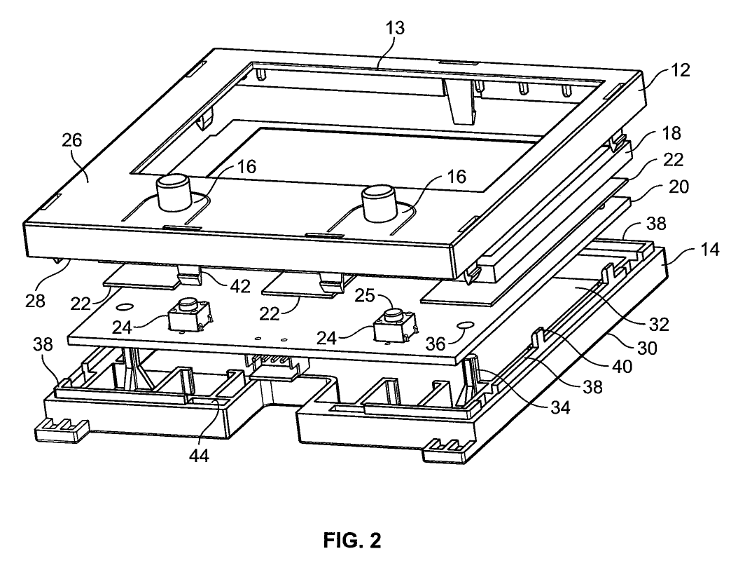

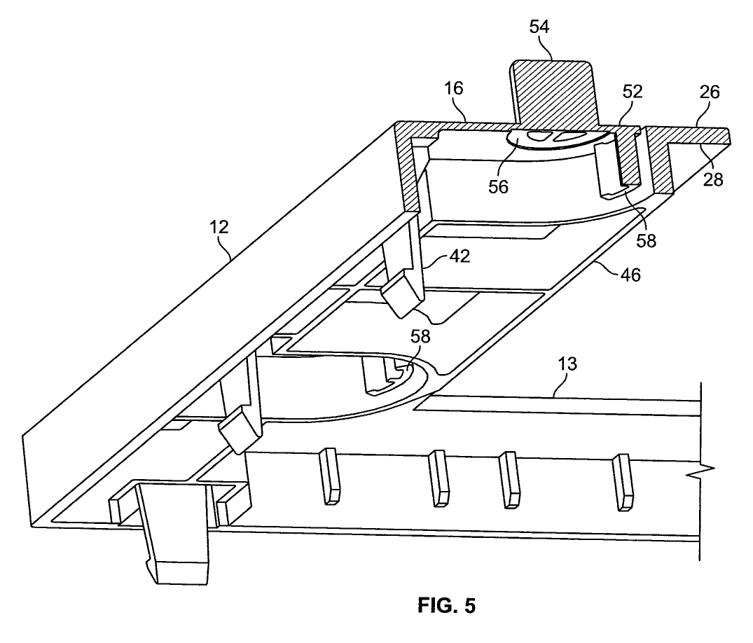

Opposite button 54 is a contact region 56 (see FIG. 5) formed in the inner surface 28 of enclosure member 12 for contacting a plunger 25 (see FIG. 2) extending from switch 24 mounted on board 20. Although contact region 56 is shown slightly recessed, contact region 56 can also protrude outwardly away from inner surface 28. Recessed/protruding contact region 56 permits compatibility with different switch configurations, such as different lengths of plungers 25 or even plungers recessed within the body of switch 24.

As shown in FIGS. 4 and 12, an interconnected protruding structure 46 extending away from inner surface 28 substantially surrounds the movable portions of flaps 52. In other words, protruding structure 46 extends adjacent the periphery of each flap 52. As further shown in FIG. 12, which is a cross section through both flaps 52, upon assembly of enclosure members 12, 14, board 20 is then disposed between protruding structure 46 of enclosure member 12 and protruding structure 48 of enclosure member 14. More specifically, protruding structure 46 and legs 50 are substantially aligned adjacent each switch 24. By virtue of this alignment, board 20 is structurally supported adjacent switch 24 by each enclosure member 12, 14. Due to the provided structural support, board 20 is able to withstand the forces associated with pressing button 54 so that contact region 56 makes compressive contact with plunger 25 of switch 24.

To prevent over-travel of flap 52, which could damage both switch 24 and the flap by virtue of overstressing the material adjacent the base of the flap, a limiter 58 (see FIGS. 4, 5) is used. Limiter 58 is preferably of unitary construction with flap 52 and extends away from inner surface 28 adjacent the end of the flap 52 opposite the base of the flap, i.e., the portion of the flap that is attached to the rest of enclosure member 12. Upon button 54 of actuator 16 being sufficiently pressed downward, limiter 58 makes abutting contact with the board 20, preventing further downward movement of flap 52.

To secure enclosure member 12 to enclosure member 14, a plurality of respective connector portions 42, 44 are engaged. In one embodiment of connector portions 42, 44 as shown in FIG. 13 for an engaged connection 110, connector portion 42 includes a pointed hook 116 that engages a shoulder 118 of connector portion 44. Stated another way, once corresponding connector portions 42, 44 are aligned, corresponding connector portions 42, 44 are directed toward each other until all of the corresponding hooks 116 and shoulders 118 are likewise engaged. It is to be understood that while a latched connection is shown, other types of connections can also be used to secure enclosure members 12, 14 together.

As shown in FIGS. 11-13, tool 100 can be used to disengage or disassemble enclosure 10, such for repair or access reasons. Tool 100 includes a base 101 having a plurality of protrusions 102 including a standoff 104 extending to a tapered portion 106 or wedge. Preferably, each protrusion 102 corresponds to a corresponding engaged connection 110 between connector portions 42, 44. Preferably, to disassemble enclosure members 12, 14 of enclosure 10, enclosure 10 is directed toward tool 100 such that each engaged connection 110 is aligned with a corresponding protrusion 102. As enclosure 10 is further brought toward tool 100, a tip 114 of each tapered portion 106 is directed into a corresponding feature 108 formed in enclosure member 14. Feature 108 is aligned with each connector portion 44. As enclosure 10 is yet further brought toward tool 100, tip 114 of tapered portion 106, is directed between connector portions 42, 44. That is, tip 114 of tapered portion 106 is directed between the point of hook 116 of connector portion 42 and an inner wall 120 of connector portion 44. Further inserting tapered portion 106 between hook 116 and inner wall 120 creates a lateral force between the inner wall 120 and hook 116 that urges hook 116 to move away from inner wall 120. The relationships between both the length and the slope of the tapered portion 106 preferably results in sufficient lateral movement of the hook 116 with respect to shoulder 118 so as to disengage the shoulder from the hook for each engaged connection 110 substantially simultaneously.

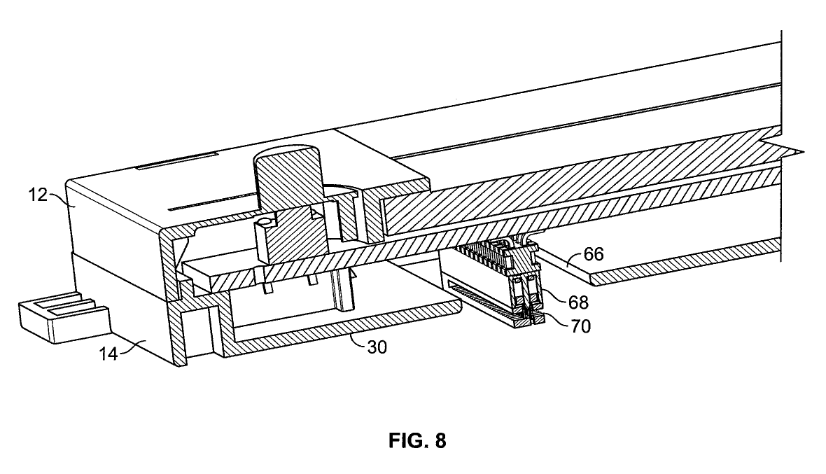

Preferably, to prevent damage to the engaged connections 110 by protrusions 102 of tool 100, or vice versa, the associated components should be properly sized. In other words, upon achieving disengagement of each engaged connection 110 between connector portions 42, 44, outer surface 30 of enclosure member 14 should abut each standoff 104. Finally, opening 119 is formed in tool 100 to provide clearance from connector 68 (see FIG. 8) that extends past the outer surface 30 of enclosure member 14 through opening 66.

With the construction as shown in the figures, one method to separate enclosure 10 using tool 100 is to apply a downward force, such as by pressing downward on the outer surface 26 of enclosure member 12 and also on tabs 60, 62 of enclosure member 14. Upon achieving disengagement of the engaged connections 110, once the downward force on enclosed member 12 is removed, enclosed member 12 can then be separated or disconnected from enclosure member 14. Alternately, due to the resilient spacer(s) 22 being compressed during assembly of enclosure 10, disassembly/disengagement of enclosure 10 can also be effected by applying a downward force only on enclosure member 14. That is, applying a downward force on tabs 60, 62 of enclosure member 14 only is sufficient to disengage enclosure member 12 from enclosure member 14, if the amount of resilient forces applied by the resilient spacers 22 between board 20 and monitor 18 is greater than the weight of enclosure member 12. In other words, upon disengagement of all engaged connections 110, and due to the resilient forces of the resilient spacers 22 returning to their uncompressed state, enclosure member 12 “pops up” or is urged to move vertically with respect to enclosure member 14, separating enclosure members 12, 14.

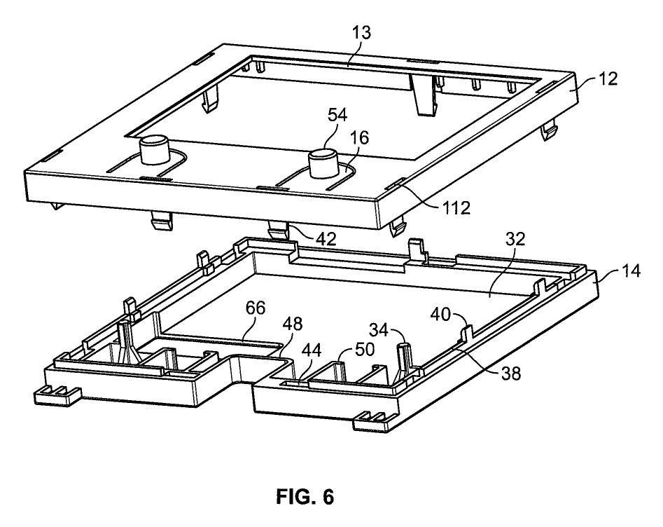

It is to be understood that while connector portions 42, 44 are shown to be substantially identical and arranged in a symmetric manner so that protrusions 102 of tool 100 are substantially identical, it is not necessary that any of the connector portions 42, 44 be substantially identical or similarly arranged. Further, it is not necessary that features 108 corresponding to the engagement of connector portions 42, 44 be associated with the same surface. For example, features 112 (see FIGS. 1, 6) also correspond to the engagement of connection portions 42, 44. However, features can also be formed in the periphery of enclosure members 12, 14, if desired. The only requirement is that the tool 100 disengages the engaged connections 110 so that the enclosure members 12, 14 can be disengaged from each other. Preferably tool 100 disengages the engaged connections 110 substantially simultaneously for ease of disassembly of enclosure members 12, 14. That is, upon protrusions 102 making sufficient physical contact with each corresponding engaged connection 110, the engaged connections become disengaged. It is to be understood that the term “substantially simultaneous” does not necessarily mean that each of the engaged connections 100 becomes disengaged at the same instant of time. The term is intended only to convey that upon tool 100 being placed at a predetermined final position with respect to the enclosure 10, i.e., each protrusion making sufficient physical contact with a corresponding engaged connection 110, that each of the engaged connections are disengaged.

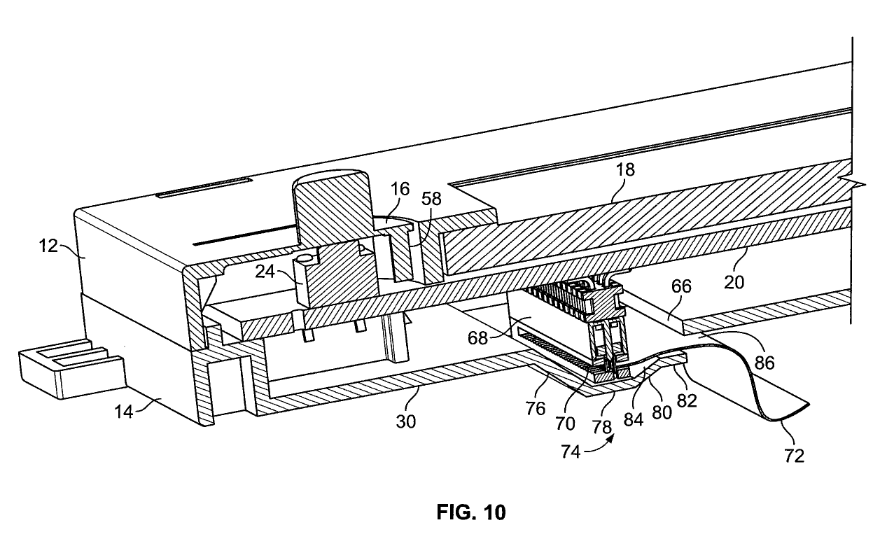

As shown in FIGS. 8-10, connector 68 extends past the plane of outer surface 30 of enclosure member 14 for connection with components exterior of enclosure 10. The type of connector 68 shown has a slot 70 to receive and secure ribbon cable 72. However, the quality of the connection between the ribbon cable 72 and connector 68 may be compromised due to forces applied to the ribbon cable, e.g., tugging on the cable. An embodiment providing strain relief for this connection is shown in FIG. 10. In this construction, instead of the portion of enclosure member 14 being removed that corresponds to opening 66, that material becomes a formed tab 74 or formed flap. Formed tab 74 includes tab segments 76, 78, 80, 82. A recess channel 84 is defined by tab segments 76, 78, 80. As shown, there is a gap 86 formed between the end of tab segment 82 and a corresponding edge of opening 66. Formed tab 74 provides structural support and acts as a strain relief for connector 86.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An enclosure comprising:
a first enclosure member having an inner surface and an outer surface comprising:
a plurality of first connector portions formed in the first enclosure member; and
a second enclosure member having an inner surface and an outer surface comprising:
a plurality of second connector portions formed in the second enclosure member, each second connector portion and a corresponding first connector portion to secure the first enclosure member to the second enclosure member upon the engagement of the plurality of first connector portions with the plurality of second connector portions; and
a plurality of features formed in at least one of the first enclosure member and the second enclosure member, each of the plurality of features corresponding to an engagement of a first connector portion with a second connector portion so as to permit substantially simultaneous disengagement of the plurality of first connector portions from the plurality of second connector portions by a tool; and
wherein a monitor, a printed circuit board and a switch are disposed between the first enclosure member and second enclosure member.

2. The enclosure of claim 1 wherein the first enclosure includes an actuator formed of unitary construction.

3. The enclosure of claim 2 wherein the actuator includes a contact region for actuating the switch.

4. The enclosure of claim 3 wherein the contact region is recessed from the inner surface.

5. The enclosure of claim 3 wherein the contact region protrudes from the inner surface.

6. The enclosure of claim 2 wherein the actuator includes a button extending away from the outer surface.

7. The enclosure of claim 6 wherein the button is formed of unitary construction with the actuator.

8. The enclosure of claim 2 including a limiter for limiting over-travel of the actuator.

9. The enclosure of claim 1 including a spacer disposed between the monitor and the printed circuit board.

10. The enclosure of claim 1 including at least one post to align the printed circuit board with the second enclosure member.

11. The enclosure of claim 10 including at least one guide formed in at least one of the first enclosure member and second enclosure member post for positioning the monitor.

12. The enclosure of claim 11 including at least one tab formed in the at least one guide for positioning the monitor.

13. The enclosure of claim 1 wherein the first enclosure member and the second enclosure member are formed by injection molding.

14. The enclosure of claim 1 wherein an opening is formed in at least one of the first enclosure member and second enclosure member for permitting electrical connection with components exterior of the enclosure.

15. The enclosure of claim 15 wherein a formed tab is formed adjacent the opening for providing strain relief for the electrical connection.

16. A tool for separating an enclosure comprising:
a base;
a plurality of protrusions extending away from the base to engage a corresponding plurality of connections between a first enclosure member and a second enclosure member, the first enclosure member and second enclosure member forming an enclosure for securing a monitor, a printed circuit board and a switch between the first enclosure member and second enclosure member; and
wherein upon the plurality of protrusions making sufficient physical contact with the plurality of connections, each of the plurality of connections are disengaged.

17. The tool of claim 16 wherein the plurality of protrusions are associated with the same surface of the enclosure.

18. The tool of claim 16 wherein the plurality of protrusions disengage the plurality of connections substantially simultaneously.

19. A method for disassembling an enclosure, the steps comprising:
providing a first enclosure member in locking engagement with a second enclosure member for securing a monitor, a printed circuit board and a switch between the first enclosure member and second enclosure member, the locking engagement achieved by a plurality of engaging fasteners between the first enclosure member and the second enclosure member;
providing a tool to disengage the first enclosure member from the second enclosure member; and
directing the engaged first enclosure member and second enclosure member into physical contact with the tool, wherein the tool substantially simultaneously disengages the plurality of engaging fasteners.

20. The method of claim 19 wherein the step of directing the engaged first enclosure member and second enclosure member includes directing a single surface of one of the engaged first enclosure member and second enclosure member into physical contact with the tool.
